(19) United States
(12) Patent Application Publication
(10) Pub. No.: US 2008/0296380 A1
(43) Pub. Date: Dec. 4, 2008

(54) NUTRITIONAL INTAKE TRACKER

(75) Inventors: Chris Demetrios Karkanias, Sammamish, WA (US); Stephen Edward Hodges, Cambridge (GB)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/754,543

(22) Filed: May 29, 2007

(51) Int. Cl. G06K 7/10

(52) U.S. Cl. 235/462.01; 235/462.1

(57) ABSTRACT

A system that facilitates tracking of nutritional intake by an individual is disclosed. The innovation employs the notion of establishing a strategy to compress nutritional information into an identifying indicia (e.g., two-dimensional barcode) that can be processed (e.g., scanned) by a wide array of devices (e.g., mobile phone, personal data assistant). In operation, the ability to inject this information into a health strategies system enhances the usability while minimizing the effort needed to capture information into the system.

### BACKGROUND

A ‘diet’ often refers to the quality and quantity of food consumed by an individual. Accordingly, ‘dietary habits’ refer to the voluntary and sometimes habitual decisions that an individual makes when selecting quality and quantities of food to eat. Today, there is an ever-growing emphasis on healthy living, and accordingly, healthy eating. This emphasis is often prompted in response to obesity, health-related events (e.g., heart attacks) or merely the will to become and remain healthy. No matter what the driving force, a majority of society is very much interested in eating a balanced diet to live a healthier life as well as to look and feel better while doing it.

Of course, healthy dietary choices may not be consistent between individuals. For example, what is considered ‘healthy’ by one individual may not be considered ‘healthy’ by another. However, a common theme of proper nutrition requires a balance of vitamins, minerals and fuel in the form of carbohydrates, proteins and fats. Today, some individuals are constantly ‘battling the bulge’ or the ‘rollercoaster of weight’ by trying to count calories and other nutritional statistics by adhering to ‘fad-type’ diets.

Most of these fad-type diets require individuals to manually track food intake. For example, one popular diet requires regulating manual journaling of carbohydrate intake throughout daily activity. Others use gimmicks such as calorie counting cards to assist individuals in keeping track of particular intake. Regardless of the method used, manual tracking is inherently vulnerable to mistakes or intentional manipulation.

Diets can be voluntary or prescribed by a health-related entity (e.g., doctor, sports trainer) in order to improve quality of life or to achieve a particular goal. More particularly, a diet may be used in part to actually gain weight, improve sports performance, improve cardio-vascular health, avoid health-related diseases, address allergies, etc. Oftentimes, types and amounts of food are specifically recommended to conform to the requirements of a particular diet. However, keeping with a prescribed diet requires manual journaling of food intake which is most often difficult to track in today's fast-paced society.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that facilitates the tracking of nutritional intake by an individual. For example, in one scenario, a restaurant or other service can provide a patron with nutritional information in the form of a hyperlink to a website hosting such information, a barcode ending such information or other suitable identifying indicia. In another embodiment, a user can scan barcodes and labels on food packaging in order to automatically record nutritional value of items consumed.

In a barcode scenario, the innovation employs the notion of establishing a strategy to encode information using a printed symbology (e.g., barcode) that can be scanned by a wide array of devices (e.g., mobile phone, personal data assistant). In operation, the ability to scan this information into a health strategies system enhances the usability while minimizing the effort needed to inject information into the system. Moreover, because there is little or no human input, error is greatly reduced.

By way of specific example, at a restaurant, a meal can be ordered, paid for with a credit card and the receipt can include a bar code or set of bar codes that establish the individual items ordered. Once scanned, it can be possible to store the information locally within the scanning device to be uploaded or transferred at a later time (e.g., when docked into an opportunistic network). In other aspects, the information can be immediately uploaded to an on-line or cloud-based remote network. This coded information can include nutritional value such as protein, carbohydrate and fat content, calories, etc. which can be uploaded and stored for later analysis with respect to nutritional reconciliations. Ultimately, this scanned information can be rendered and/or employed in the context of a specific health record. Thus, portion size can be regulated in context with activity, food type, time of day, etc.

In yet another aspect thereof, artificial intelligence and/or machine learning and reasoning logic is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates nutritional information tracking in accordance with an aspect of the innovation.

FIG. 2 illustrates an example flow chart of procedures that facilitate selection, generation and render of identifying indicia in accordance with an aspect of the innovation.

FIG. 3 illustrates an example flow chart of procedures that facilitate processing an identifying indicia in accordance with an aspect of the innovation.

FIG. 4A illustrates an example flow chart of procedures that facilitate generating a barcode that encodes nutritional information in accordance with an aspect of the innovation.

FIG. 4B illustrates an example flow chart of procedures that facilitate process the barcode in accordance with an aspect of the innovation.

FIG. 5 illustrates an alternative block diagram of a system that facilitates nutritional information tracking in accordance with an aspect of the innovation.

FIG. 6 illustrates a block diagram of an indicia management component that establishes an identifying indicia in accordance with an aspect of the innovation.

FIG. 7 illustrates a block diagram of a communication component that renders an identifying indicia to a client in accordance with an aspect of the innovation.

FIG. 8 illustrates a block diagram of a rendering component that facilitates selection of an appropriate protocol to transfer an identifying indicia to a client in accordance with an aspect of the innovation.

FIG. 9 illustrates a block diagram of a nutritional information access component that facilitates processing identifying indicia in accordance with an aspect of the innovation.

FIG. 10 illustrates an architecture including machine learning and reasoning-based component that can automate functionality in accordance with an aspect of the novel innovation.

FIG. 11 illustrates a block diagram of an example mobile device that facilitates processing identifying indicia in accordance with an aspect of the innovation.

FIG. 12 illustrates a block diagram of a computer operable to execute the disclosed architecture.

FIG. 13 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

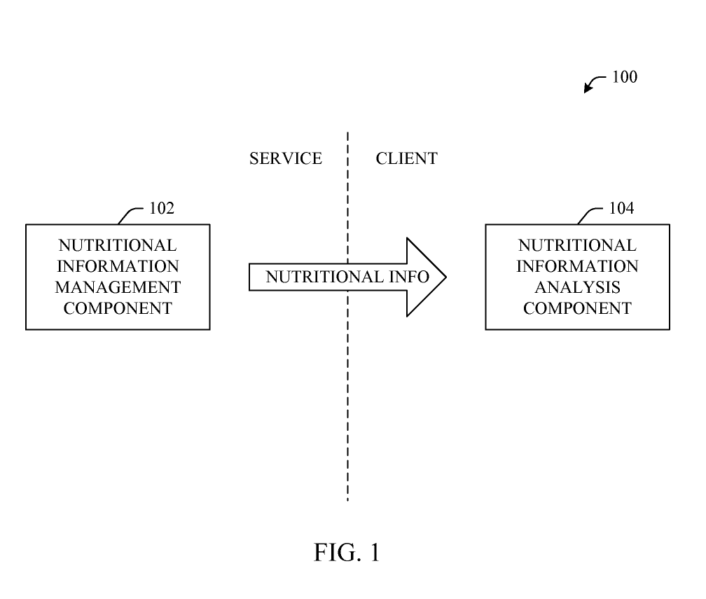

Referring initially to the drawings, FIG. 1 illustrates a system 100 that facilitates nutritional tracking in accordance with an aspect of the innovation. Generally, the system 100 can include a nutritional information management component 102 that generates nutritional information related to dietary intake of an individual. A nutritional information analysis component 104 can be employed to automatically access the nutritional information. In aspects, the nutritional information can be logged by the service, client, in a cloud, or combination thereof. These aspects will be better understood upon a review of the figures that follow.

The system 100 employs the notion of establishing a strategy to compress information into a transferable form (e.g., via a printed symbology (e.g., barcode)) that can be understood (e.g., scanned) by a wide array of devices. In operation, the ability to accept (e.g., scan) this information into health strategies systems enhances the usability of the information while minimizing the effort needed to inject the information into the system 100.

By way of example, at a restaurant (e.g., service), a meal can be ordered, paid for with a credit card and the receipt can be printed to include a bar code or set of bar codes that identify the individual items ordered. Once scanned by a patron (e.g., client), the information can be stored locally within a scanning device (e.g., nutritional information analysis component 104) to be uploaded or transferred at a later time (e.g., when docked to a network). In other aspects, the information can be immediately uploaded to an on-line or cloud-based remote network.

It is to be understood and appreciated that this coded information can include fat content, calories, processing information, etc. which can be uploaded and stored for later analysis with respect to nutritional reconciliations. Alternatively, the code can merely identify the items and portion sizes whereby specific nutritional characteristics can be gathered using a query of a cloud (e.g., Internet) or other data storage mechanism. In either instance, the transfer of nutritional information can be accurate and seamless to a user thereby enhancing the usability of nutritional tracking system 100. Ultimately, this information can be rendered, stored and/or employed in the context of a specific health record. Thus, nutritional aspects can be evaluated and/or regulated within context related to activity, food type, time of day, etc.

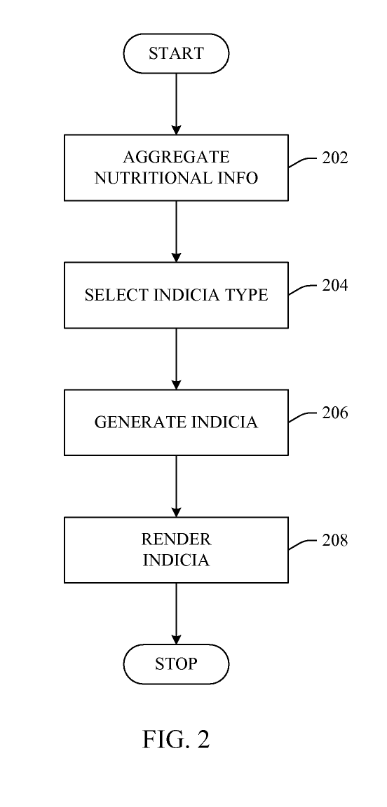

FIG. 2 illustrates a methodology of compiling nutritional information in accordance with an aspect of the innovation. Essentially, in an aspect, this methodology can be viewed as acts of the service side of the system 100 of FIG. 1. However, while many of the examples described herein are directed to a restaurant scenario, it is to be understood that the information can be gathered and incorporated into an indicia or code (e.g., barcode) by other entities. For instance, a food manufacturing or packaging company can incorporate nutritional information into a barcode (or other identifying indicia) which can be placed on the packaging. Thus, when an individual consumes the product, the code can be analyzed (e.g., scanned) in order to automatically document the nutritional characteristics into a log or other storage mechanism.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, nutritional information can be aggregated, for example, calories, carbohydrates, vitamin amounts, protein amounts, fat content, etc. An indicia type can be selected at 204. By way of example, a barcode can be used as indicia to encode information relating to nutritional intake. As will be understood, a ‘barcode’ is a machine-readable representation that uses a printed symbology such as dark ink on a light substrate to create high and low reflectance which, when scanned, can be converted into binary 1's and 0's. While original barcodes stored data in the widths and spacing of parallel lines, today, barcodes can additionally employ patterns of dots, concentric circles, etc.

Traditionally, barcode encoding schemes represented only numbers; however, newer symbologies add new characters such as the uppercase alphabet to the complete ASCII character set and beyond. The drive to encode more information in combination with the space requirements of simple barcodes led to the development of ‘matrix codes’ (a type of two-dimensional (2D) barcode), which, contrary to their name, do not consist of bars but rather a grid of square cells. Similarly, ‘stacked barcodes’ are a compromise between true 2D barcodes and linear codes, and are formed by taking a traditional linear symbology and placing it in an envelope that allows multiple rows.

At 206, the indicia (e.g., barcode) can be generated. While the aforementioned example addresses barcodes as the indicia, it is to be understood that other examples employ other suitable indicia (e.g., matrix codes, hyperlinks, universal resource locator (URL)) without departing from the spirit and scope of this specification and claims appended hereto. At 208, the indicia can be rendered (e.g., printed, displayed, transmitted). Referring again to the system 100 of FIG. 1, here the indicia can be rendered from the service (e.g., restaurant, food processor) to a client (e.g., individual, health care entity) by being printed upon a credit card receipt or the like.

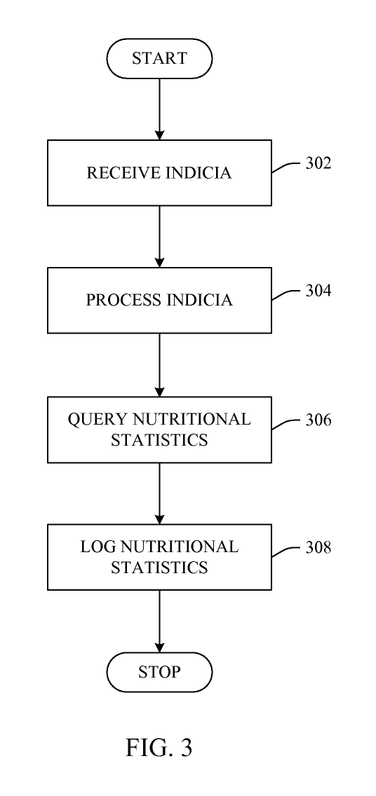

Turning now to FIG. 3, there is illustrated a methodology of interpreting indicia in accordance with the innovation. At 302, the indicia can be received. For instance, the barcode which is printed upon a receipt as indicated in the methodology described in FIG. 2 can be received and processed at 304. Here, at 304, processing can refer to any act of interpreting the indicia. For instance, the act in 304 can refer to an act of scanning the barcode in order to determine information encoded therein. In another embodiment, for example a URL, the act of processing indicia at 304 can refer to an act of accessing a particular website designated by the URL.

At 306, a query can be employed to establish nutritional statistics related to the identified information. For example, suppose the bar code reveals that a specific portion size and type of meat was consumed. Here, at 306, nutritional statistics can be gathered by way of a data store, cloud, etc. to further establish the sustenance of the foodstuff. In alternative aspects, if possible, the actual statistics can be incorporated into the indicia. Additionally, it will be understood that other information related to the nutritional information can be queried for, analyzed and logged at 308.

Once the information is logged at 308, it can be employed for most any purpose desired. For instance, the information can be provided to a health-care professional in order to assess adherence to a specified or prescribed diet. In operation, the information can be logged locally and subsequently transferred to a server or other target upon ‘docking’ (e.g., wired or wireless). In a specific example, the information can be stored locally on a mobile device and transferred via an opportunistic network upon detection of an available connection. In this example, a user can visit a restaurant, order a meal and receive the nutritional information directly onto their mobile device. When they arrive home, the mobile device can automatically ‘dock’ to a home network and the information can subsequently be transferred and compiled with other nutritional information within the home network. Thus, an automatic nutritional journal can be established seamlessly without intervention by the user.

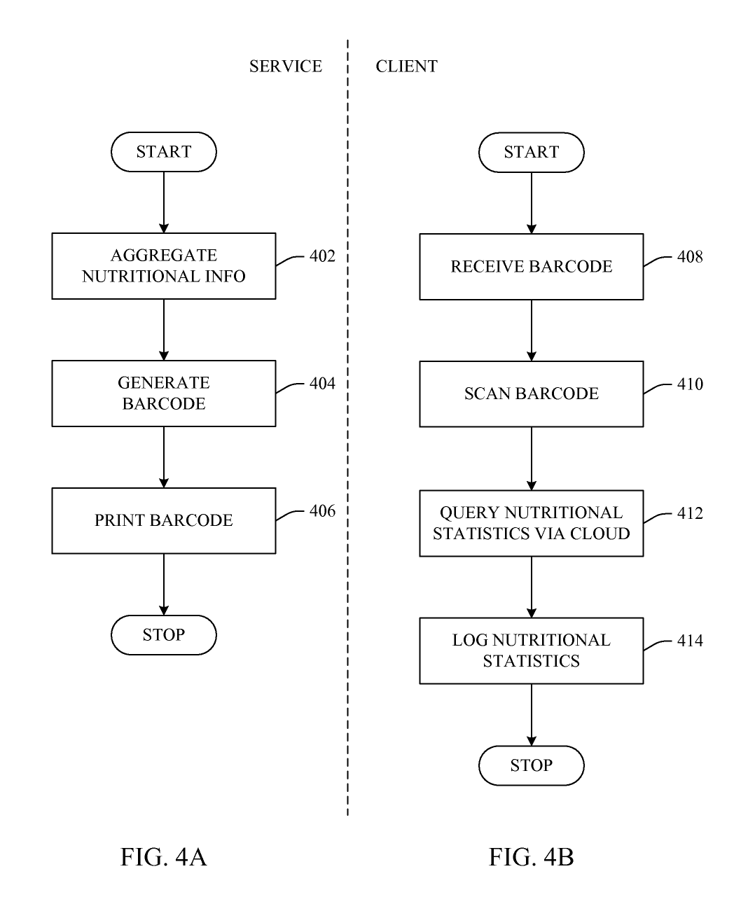

FIGS. 4A and 4B illustrate methodologies of generating and interpreting nutritional indicia in accordance with aspects of the innovation. As stated above, while these methodologies employ barcodes to embody nutritional information, it is to be understood that most any suitable symbol or identifier can be employed to either incorporate the information or to point to a source where the information can be obtained. For instance, a URL can be provided to navigate to a third party service in a cloud or to the originating source (e.g., restaurant, food manufacturer) where specific nutritional information can be obtained.

Referring first to FIG. 4A, at 402, nutritional information can be aggregated. By way of example, after a meal is presented and consumed by a patron, a restaurant can aggregate information related to all foodstuff items. In a specific example, information related to drinks, appetizers, main course and dessert can be aggregated. This information can include most any characteristics including, but not limited to, portion sizes, ingredients, calories, proteins, fat grams, etc.

A barcode which incorporates the nutritional information can be generated at 404. As described, above a 2D barcode can be generated to incorporate the information. This 2D barcode can be printed at 406, for example on a credit card receipt. Alternatively, the information can be automatically transferred (e.g., via an opportunistic network connection) into the patron's mobile device (e.g., cell phone, smartphone, personal digital assistant).

In addition to, or in place of, printing the barcode, the bar code (or other indicia) can be electronically transferred to a user by way of electronic protocols. By way of example, and not limitation, the information can be transferred via email, instant message (IM), SMS (short message service (text message)), etc. Once sent, this information can be automatically received and interpreted as described with reference to FIG. 4B.

Turning now to FIG. 4B, a methodology of interpreting the barcode and logging the nutritional information is shown. At 408, the barcode is received. As described supra, the barcode can be physically given to a user on a paper credit card receipt. Alternatively, the information can be sent via electronic protocol. In the case of a barcode, at 410, the barcode can be scanned to interpret the information encoded therein.

Additional nutritional statistics can be queried by way of a cloud or other network service. For instance, the receiving device can automatically employ a search engine to query the Internet to obtain specific or additional nutritional information related to the information encoded within the barcode. In other words, if the barcode merely includes portions and ingredients, supplemental information can be obtained from the Internet. For example, information related to the calories and other nutritional value can be obtained at 412.

At 414, the information can be logged into a health-related journal of nutritional information. It is to be understood that the log can be used for most any purpose desired. In one example, the log can be used merely to track eating patterns for food management. In another example, the log can be used for a specific weight management program. Still further, the log can be used to assist in behavior modification as related to eating habits of an individual.

Essentially, the nutritional information tracking functionality of the innovation enables patterns of activity (e.g., dietary intake) to be recorded in a flexible manner. From an outbound perspective, the functionality enables actions to be recorded. Similarly, from an inbound perspective, the functionality enables actions to be controlled, for example, by specifying what items are acceptable to consume. As described above, the indicium (e.g., barcode) represents a mechanism that represents a pattern of nutritional intake in an offline manner.

In accordance with the features functions and benefits of the innovation, there are at least three scenarios that can be employed in connection with providing a printed code, for example a 2D barcode or URL. In a first scenario, a user can employ a scanning device, for example within a home network or on a mobile device, to scan the code thereby retrieving information encoded therein. In a second scenario, rather than encoding the detailed information within a barcode, the service could simply provide a third party URL which can be used to retrieve the information. Here, a third party can be engaged thus taking burden away from both the service as well as the client with regard to maintaining the information or employing additional hardware devices respectively. In yet a third scenario, the service itself can host a mechanism which maintains the nutritional information. In this scenario, rather than the client connecting to a third party, here, they would essentially connect directly to the restaurant to access and/or retrieve the information. In this scenario, a suitable code and identifying parameters can be supplied to the user in order to identify the correct information.

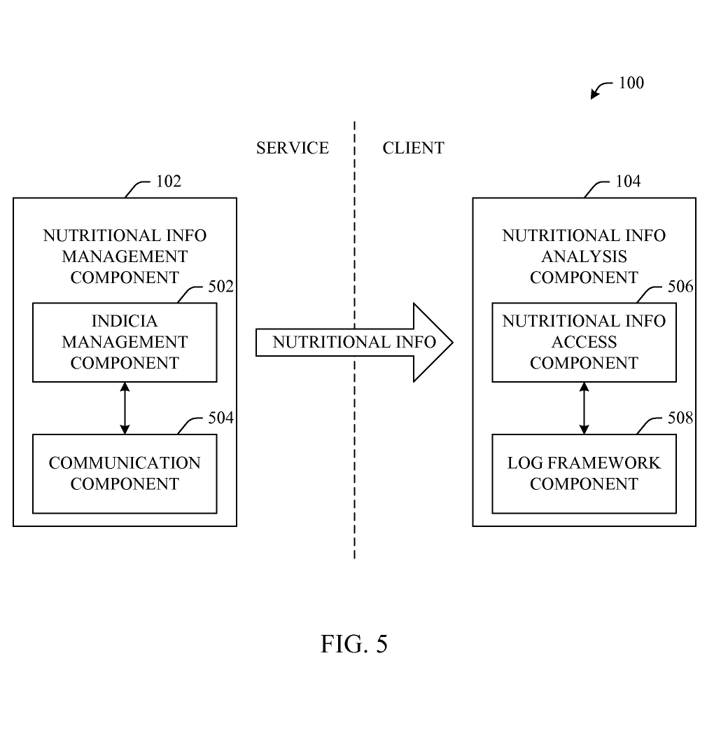

Referring now to FIG. 5, an alternative block diagram of system 100 is shown. As illustrated, the nutritional information management component 102 can include an indicia management component 502 and a communication component 504. Similarly, the nutritional informational analysis component 104 can include a nutritional information access component 506 and a log framework component 508. Each of these sub-components will be described in greater detail infra.

The indicia management component 502 can select the type of indicia or identifier (e.g., barcode) for which to embody the nutritional information. Further, the indicia management component 502 can aggregate appropriate information (e.g., food type, processing information, calories, proteins, vitamins) and subsequently generate appropriate indicia to communicate the information.

The communication component 504 can be employed to actually communicate the information. In one example, communication can be of the form of printing the barcode onto a tangible receipt. In other examples, information can be electronically transferred to a mobile device using most any wired or wireless protocol (e.g., Bluetooth, infrared, Wi-Fi). Still further, a URL or other pointer can be employed to convey sufficient information to enable a user to locate the information in a cloud or other storage location. It will be understood that the information can be managed by an originating service or a third-party service provider.

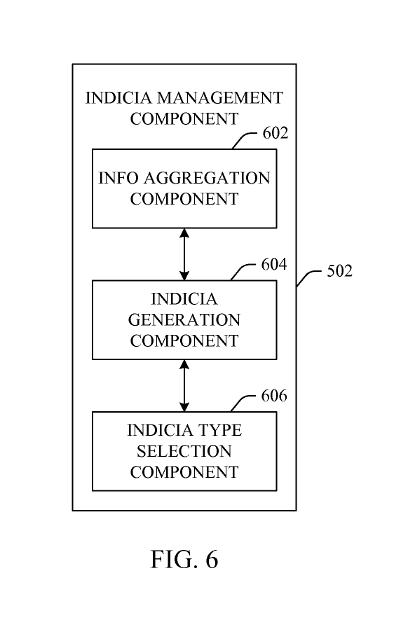

Turning now to FIG. 6, an example block diagram of an indicia management component 502 is shown. Generally, the component 502 can include an information aggregation component 602, an indicia generation component 604 and an indicia type selection component 606. In operation, the information aggregation component 602 can facilitate gathering the information that is to be incorporated and communicated. For instance, the aggregation component 602 can gather information regarding all items consumed during a meal. This information can be gathered in most any suitable manner, for example, by integrating into a service computer system that tracks items ordered for billing purposes. Additionally, a server can manually enter items consumed into the component 602. Still further, mechanisms can be employed to account for partial consumption of a particular item. For example, it can be possible for a server to approximate the amount consumed (e.g., 75%) by a patron.

The indicia type selection component 606 can be employed to determine an appropriate manner by which to convey the information. For instance, if a paper receipt is to be printed, it can be possible to select a barcode which can be printed upon the receipt. In another example, if the transaction is completely electronic (e.g., debit card without a receipt), the information can be conveyed via email, SMS, or the like.

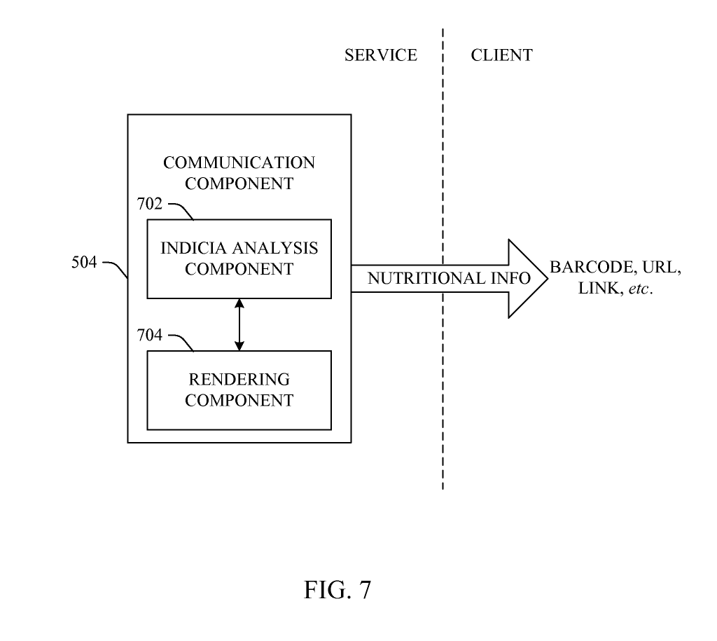

The indicia generation component 604 can be employed to establish the means to convey the information. In other words, the generation component 604 can combine the aggregated information into the selected indicia type thereby enabling communication to a user. FIG. 7 illustrates an example communication component 504 that is capable of effectuating the transfer to a user.

Referring to FIG. 7, the communication component 504 can include an indicia analysis component 702 and a rendering component 704. In operation, the analysis component 702 can establish the type of indicia used (e.g., barcode, URL). The rendering component 704 can select an appropriate mechanism by which to render the information to a target location (e.g., user, device, application).

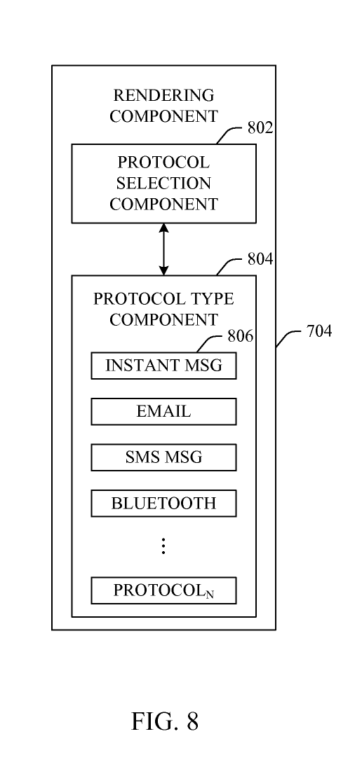

FIG. 8 illustrates an example rendering component 704 in accordance with an aspect of the innovation. Essentially, the rendering component 704 can include a protocol selection component 802 and a protocol type component 804. In use, the protocol selection component 802 can select one or more communication protocol types (806) from within the protocol type component 804. Effectively, the protocol type component 804 can maintain a list of 1 to N available protocol types, were N is an integer. As illustrated, the protocol type component 804 can include protocol information associated with, but not limited to, IM, email, SMS message, wireless transfer (e.g., Bluetooth), or the like. Once an appropriate communication protocol, or group of protocols is selected, the indicia information can be conveyed to a target location (e.g., client).

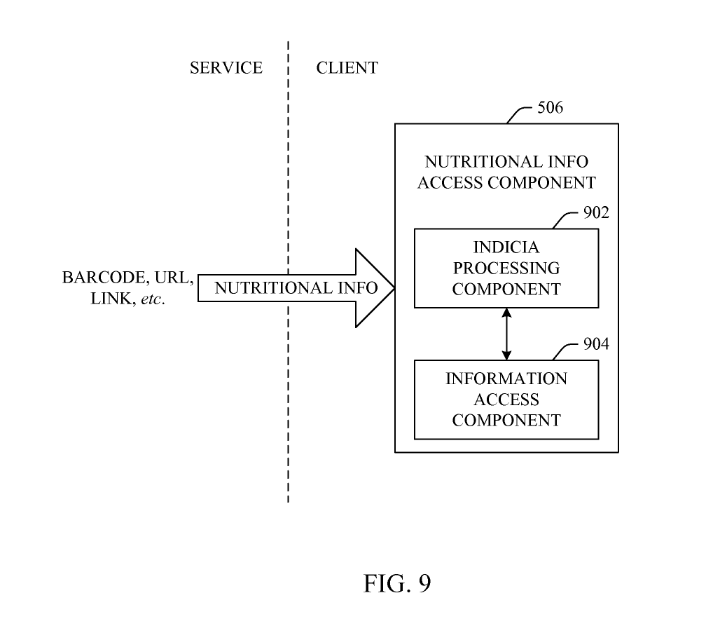

Referring now to FIG. 9, an example nutritional information access component 506 is shown. Generally, the access component 506 can include an indicia processing component 902 and an information access component 904. In one example, the nutritional information access component 506 can be a scanner and associated logic such that a barcode provided by a service (e.g., restaurant) can be scanned to gain access to the information encoded therein.

Essentially, the indicia processing component 902 is illustrative of a means to decipher or gain access to the code. As in the above example, the indicia processing component 902 can be representative of a scanner. In another example, e.g., URL scenario, the processing component 902 can be representative of a browser such that information can be accessed from a cloud or other suitable storage mechanism.

The information access component 904 can be employed to retrieve supplemental or detailed information related to the supplied information. It is to be understood that the barcode can potentially include information that identifies food group, portion size and ingredients. However, it is possible that actual nutritional characteristics (e.g., proteins, calories, fat, carbohydrates) are not included within the coded information. Here, the information access component 904 can be employed to gain access to this information from some external source (e.g., Internet, cloud). Thus, a complete set of information can be logged within the nutritional log (e.g., 508 of FIG. 5) for access and/or analysis.

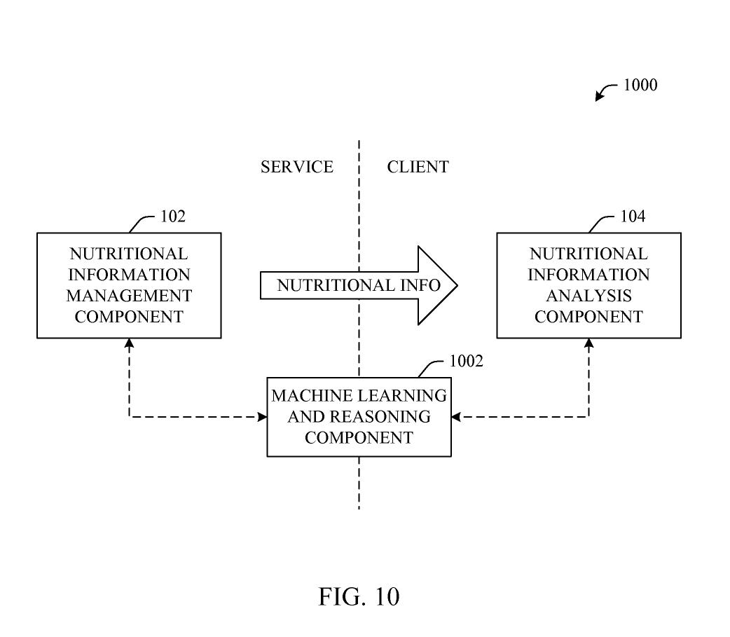

FIG. 10 illustrates a system 1000 that employs an artificial intelligence (AI) or machine learning and reasoning component 1002 which facilitates automating one or more features in accordance with the subject innovation. The subject innovation (e.g., in connection with indicia or protocol selection) can employ various AI-based schemes for carrying out various aspects thereof. For example, a process for determining what type of indicia to employ or what protocol to use to communicate the information can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria what type of indicia or protocol to employ in a particular context, how much of a portion is consumed as a function of patron, food type, context, time elapsed, etc.

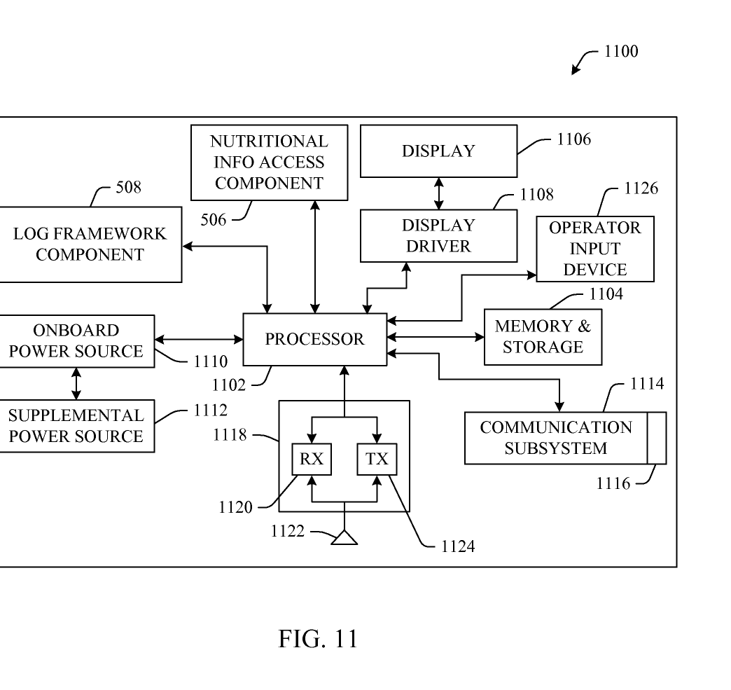

Referring now to FIG. 11, there is illustrated a schematic block diagram of a portable device 1100 according to one aspect of the subject innovation, in which a processor 1102 is responsible for controlling the general operation of the device 1100. It is to be understood that the portable device 1100 can be representative of most any portable device including, but not limited to, a cell phone, smartphone, personal digital assistant (PDA), a personal music player, image capture device (e.g., camera), personal game station, health monitoring device, event recorder component, etc.

The processor 1102 can be programmed to control and operate the various components within the device 1100 in order to carry out the various functions described herein. The processor 1102 can be any of a plurality of suitable processors. The manner in which the processor 1102 can be programmed to carry out the functions relating to the subject innovation will be readily apparent to those having ordinary skill in the art based on the description provided herein. As was described in greater detail supra, an MLR component can be used to effect an automatic action of processor 1102.

A memory and storage component 1104 connected to the processor 1102 serves to store program code executed by the processor 1102, and also serves as a storage means for storing information such as data, services, metadata, device states or the like. In aspects, this memory and storage component 1104 can be employed in conjunction with other memory mechanisms that house nutrition-related data, for example, log framework component 508. As well, in other aspects, the memory and storage component 1104 can be a stand-alone storage device or otherwise synchronized with a cloud or disparate network based storage means, thereby establishing a local on-board storage of nutrition-related data.

The memory 1104 can be a non-volatile memory suitably adapted to store at least a complete set of the information that is acquired. Thus, the memory 1104 can include a RAM or flash memory for high-speed access by the processor 1102 and/or a mass storage memory, e.g., a micro drive capable of storing gigabytes of data that comprises text, images, audio, and video content. According to one aspect, the memory 1104 has sufficient storage capacity to store multiple sets of information relating to disparate services, and the processor 1102 could include a program for alternating or cycling between various sets of information corresponding to disparate services.

A display 1106 can be coupled to the processor 1102 via a display driver system 1108. The display 1106 can be a color liquid crystal display (LCD), plasma display, touch screen display or the like. In one example, the display 1106 is a touch screen display. The display 1106 functions to present data, graphics, or other information content. Additionally, the display 1106 can display a variety of functions that control the execution of the device 1100. For example, in a touch screen example, the display 1106 can display touch selection buttons which can facilitate a user to interface more easily with the functionalities of the device 1100.

Power can be provided to the processor 1102 and other components forming the device 1100 by an onboard power system 1110 (e.g., a battery pack). In the event that the power system 1110 fails or becomes disconnected from the device 1100, a supplemental power source 1112 can be employed to provide power to the processor 1102 (and other components (e.g., sensors, image capture device)) and to charge the onboard power system 1110. The processor 1102 of the device 1100 can induce a sleep mode to reduce the current draw upon detection of an anticipated power failure.

The device 1100 includes a communication subsystem 1114 having a data communication port 1116, which is employed to interface the processor 1102 with a remote computer, server, service, or the like. The port 1116 can include at least one of Universal Serial Bus (USB) and IEEE 1394 serial communications capabilities. Other technologies can also be included, but are not limited to, for example, infrared communication utilizing an infrared data port, Bluetooth™, etc.

The device 1100 can also include a radio frequency (RF) transceiver section 1118 in operative communication with the processor 1102. The RF section 1118 includes an RF receiver 1120, which receives RF signals from a remote device via an antenna 1122 and can demodulate the signal to obtain digital information modulated therein. The RF section 1118 also includes an RF transmitter 1124 for transmitting information (e.g., data, service) to a remote device, for example, in response to manual user input via a user input 1126 (e.g., a keypad) or automatically in response to a detection of entering and/or anticipation of leaving a communication range or other predetermined and programmed criteria.

A nutritional information access component 506 is provided which, as described supra, can facilitate access and/or management of user-specific nutritional data. A log framework component 508 can be employed to define format and/or store nutritional information within the device 1100. It is to be appreciated that these components can enable functionality of like-named components (and sub-components) described supra.

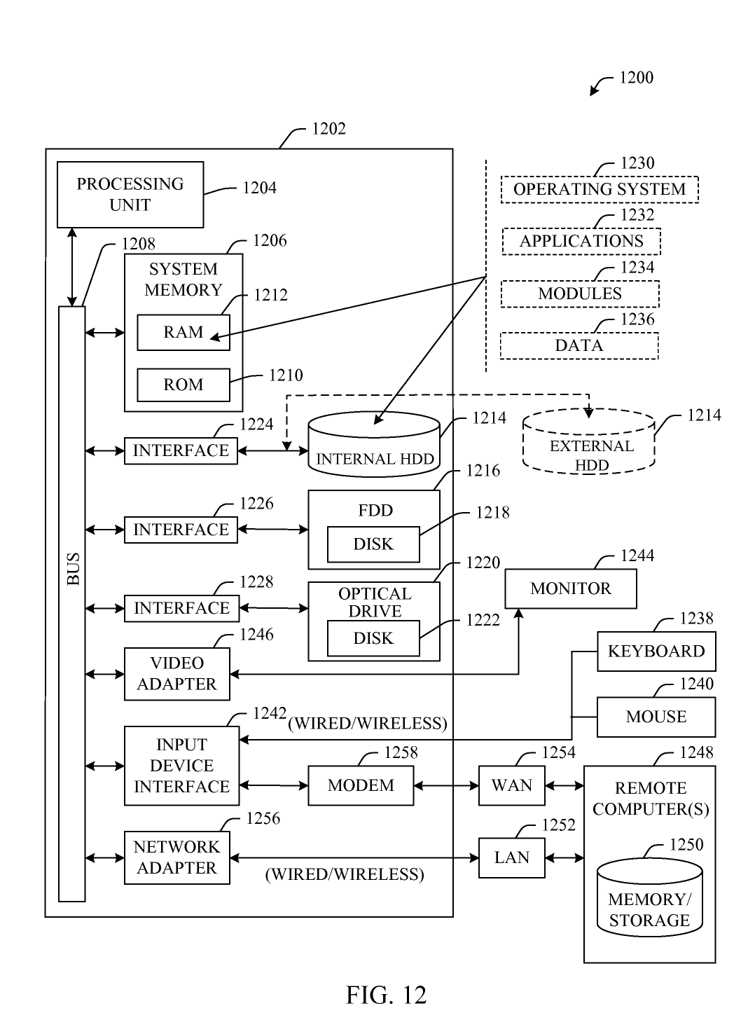

Referring now to FIG. 12, there is illustrated a block diagram of a computer operable to execute the disclosed architecture. In order to provide additional context for various aspects of the subject innovation, FIG. 12 and the following discussion are intended to provide a brief, general description of a suitable computing environment 1200 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects of the innovation includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1130 is illustrated. The logical connections depicted include wired/wireless connectivity to a local area network (LAN) 1132 and/or larger networks, e.g. a wide area network (WAN) 1134. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1132 through a wired and/or wireless communication network interface or adapter 1136. The adapter 1136 may facilitate wired or wireless communication to the LAN 1132, which may also include a wireless access point disposed thereon for communicating with the wireless adapter 1136.

When used in a WAN networking environment, the computer 1202 can include a modem 1138, or is connected to a communications server on the WAN 1134, or has other means for establishing communications over the WAN 1134, such as by way of the Internet. The modem 1138, which can be internal or external and a wired or wireless device, is connected to the system bus 1208 via the serial port interface 1242. In a networked environment, program modules depicted relative to the computer 1202, or portions thereof, can be stored in the remote memory/storage device 1130. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

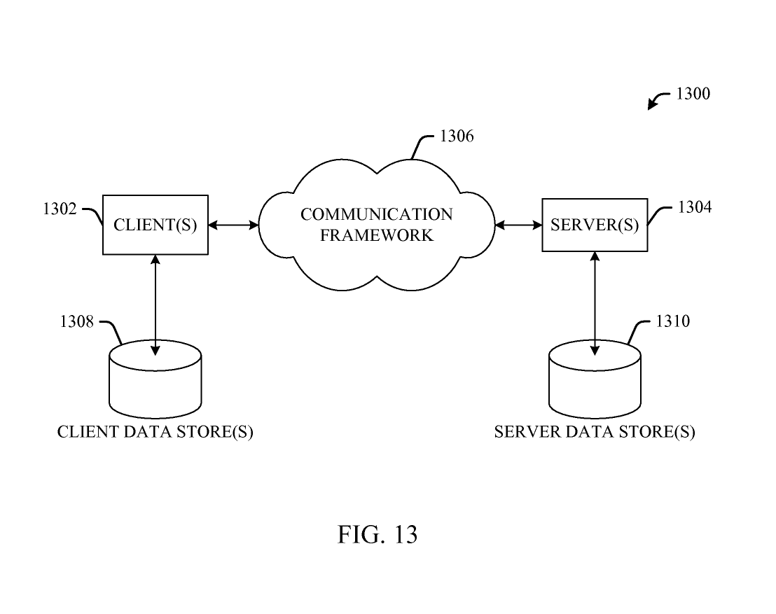

Referring now to FIG. 13, there is illustrated a schematic block diagram of an exemplary computing environment 1300 in accordance with the subject innovation. The system 1300 includes one or more client(s) 1302. The client(s) 1302 can be hardware and/or software (e.g., threads, processes, computing devices). The client(s) 1302 can house cookie(s) and/or associated contextual information by employing the innovation, for example.

The system 1300 also includes one or more server(s) 1304. The server(s) 1304 can also be hardware and/or software (e.g., threads, processes, computing devices). The servers 1304 can house threads to perform transformations by employing the innovation, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates tracking of nutritional information, comprising:
an indicia management component that incorporates nutritional information into an identifying indicia; and
a communication component that conveys the nutritional information to a target.

2. The system of claim 1, wherein the identifying indicia is one of a one-dimensional (linear) or two-dimensional barcode.

3. The system of claim 1, further comprising an information aggregation component that gathers nutritional information, wherein the nutritional information represents a plurality of items consumed during an event.

4. The system of claim 1, further comprising an indicia selection component that chooses a type of the identifying indicia from a plurality of available indicia types.

5. The system of claim 4, wherein the indicia selection component chooses the type as a function of one of user or device context or capability.

6. The system of claim 1, further comprising an indicia generation component that establishes the identifying indicia that makes the nutritional information available to the target.

7. The system of claim 6, further comprising an indicia analysis component that evaluates the identifying indicia and determines an effective method of rendering the identifying indicia.

8. The system of claim 6, further comprising a rendering component that delivers the identifying indicia to the target.

9. The system of claim 8, further comprising a protocol selection component that chooses a protocol type by which to deliver the identifying indicia.

10. The system of claim 8, the protocol type is at least one of instant message, email, short message service (SMS), Bluetooth transfer, peer-to-peer or infrared transfer.

11. The system of claim 1, further comprising a nutritional information access component that employs an indicia processing component that obtains the nutritional information by way of the identifying indicia.

12. The system of claim 11, the indicia processing component is at least one of a scanner, radio frequency information tag reader, magnetic card reader, or browser.

13. The system of claim 12, further comprising an information access component that enables access to supplemental nutritional information based at least in part upon context of the processed identifying indicia.

14. The system of claim 11, further comprising a log framework component that formats, categorizes and maintains the nutritional information.

15. The system of claim 1, further comprising a machine learning and reasoning component that employs at least one of a probabilistic and a statistical-based analysis that infers an action that a user desires to be automatically performed.

16. A computer-implemented method of tracking nutritional information, comprising:
gathering nutritional information related to an event;
incorporating the nutritional information into an identifier; and
communicating the identifier to a user upon completion of the event.

17. The computer-implemented method of claim 16, further comprising determining the nutritional information by way of analyzing the identifier.

18. The computer-implemented method of claim 17, further comprising scanning the identifier to access the nutritional information, wherein the identifier is a barcode.

19. A computer-executable system comprising:
means for analyzing an identifying indicia that represents nutritional information related to a plurality of foodstuff items consumed during an event; and
means for extracting the nutritional information from the identifying indicia.

20. The computer-executable system of claim 19, further comprising:
means for gathering the nutritional information;
means for incorporating the nutritional information into the identifying indicia; and
means for transferring the identifying indicia to a user.
